(19) United States
(12) Patent Application Publication
(10) Pub. No.: US 2011/0257780 A1
(43) Pub. Date: Oct. 20, 2011

(54) Method of Generating a Greeting Card

(76) Inventor: Rodger Cosgrove, Riverside, CA (US)

(21) Appl. No.: 13/047,791

(22) Filed: Mar. 14, 2011

Related U.S. Application Data
(60) Provisional application No. 61/323,936, filed on Apr. 14, 2010.

(51) Int. Cl. G06F 19/00

(52) U.S. Cl. 700/117

(57) ABSTRACT

A method of generating a greeting card where a user selects at a template for a greeting card from a plurality of templates, the user personalizes the greeting card with text or graphical information to create a graphic composition, the user optically scans hand-written information at a kiosk, and the user superimposes the optically scanned hand written information with the graphic composition. The greeting card is then manufactured.

### BACKGROUND

One problem with giving a greeting card to another person is finding a greeting card that contains a desired message and has an appropriate picture or other graphic elements. Often, a card will have a desired picture but not a desired text message. Many times, the card may be perceived as too wordy, too sentimental, too corny, too serious or perhaps not having enough of any of these qualities. In short, it is often not possible to find a “perfect” card for a birthday, anniversary, Valentine's Day, or other occasion. One often must settle for a less than optimal card presentation.

Another problem with the way cards are currently purchased is that sometimes after a person has spent time selecting a satisfactory card, and spent money to buy it, the buyer may then make a mistake while writing a personal message in ink inside the card. The buyer must either buy another card, or give a card with the mistake crossed out, covered with liquid paper, or some other less than satisfactory remedy.

### DESCRIPTION

The present invention allows a buyer to compose and/or modify a “custom” greeting card in digital form and have the card manufactured immediately after the buyer is satisfied with the total composition. If a card design is desired by a buyer except for unsatisfactory text, a buyer is able to edit the text. The buyer is able to change the font, font size, italic, bold, underline, etc. If the text is perfect, but a buyer does not like the picture or graphic, the buyer is able to select a different picture or graphic. Additionally, the user is able to write a personal message and signature on a blank or template imprinted sheet of “scratch” paper, scan this handwritten sheet, and have the image of handwriting printed on the card as if it were written by hand. If a mistake is made while handwriting the message, the buyer is able to write a new message on another sheet of scratch paper and use that instead. The buyer could also edit any scanned image to delete or correct a mistake before the card is printed.

In one embodiment, the invention provides a self-service kiosk or other consumer-facing format (“Card Kiosk”) which enables the user to compose, order production, mail and pay for a highly customized, “perfectible” greeting card and matching envelope or other graphic communication format.

The Card Kiosk may be a physical kiosk designed for a retail environment which provides the consumer with one or more of the following:
1. A display screen, preferably of high resolution digital, more preferably with touch screen functionality such as is typically used in ATM's or other kiosk applications.
2. A method of inputting data manually such as a QWERTY keyboard, whether physical buttons or more virtually on a touch-screen display which would allow for other graphic icons to be used for various functions.
3. A capability to optically scan paper, probably a small, high resolution flat bed scanner.
4. A pad or supply of “scratch” paper, a writing surface and a pen or set of pens.
5. A “user interface” (UI) that enables the user to:
   a) preview different digital assets such as graphic designs or text to use as components in composing a greeting card;
   b) modify or upload such graphics or text;
   c) preview an image such as a personal note or signature scanned at the kiosk and superimposed on the rest of a digitally composed card so as to present an integrated What You See Is What You Get (“WYSIWYG”) image of all the graphic and/or text components the user included and how the card and envelope will look when printed;
   d) a point of sale (POS) to initiate, approve and pay for production and mailing services.
In one embodiment, the Card Kiosk also provides printing and bindery or lettershop functions including:
   a) a high quality printer such as a high resolution ink-jet printer to image the card on an appropriate paper substrate;
   b) trimming knives to enable the printed image to bleed off the card image
   c) a scoring wheel to score a spine for folding the card
   d) a paper transport mechanism to feed the paper substrate through the printing and trimming process and deliver it out of the kiosk to the buyer

The Card Kiosk's UI may be enabled by either: (A) An internet connection for web services or “cloud” based computing to access a library of images or connections to image resources, access a library of text or connections to text resources, upload and/or order third party images or text, preview digital proofs of custom composed graphic presentations, or otherwise engage in composing and managing production through an “application service provider” (ASP) or “Software as a Service” (SaaS) type of platform; or, (B) some UI functionality could be enabled by software and digital storage physically located on the Card Kiosk to reduce latency in web based UI reactions to user commands.

Although the Card Kiosk functions could be presented or organized in various ways, an illustrative example of one embodiment of hardware, software and user actions might be a display cabinet about 20 inches deep, 24 to 48 inches wide, and 60 to 72 inches tall, which would fit into the typical modular design of modern store fixtures. The cabinet (kiosk) could have a high resolution computer screen at eye level or lower and below or beside that a compact high resolution optical scanner bed. The kiosk could either accept payment via magnetic card technology, i.e., debit or credit card, by accepting cash, or by providing a coded receipt for payment at another point of sale such as a cash register and/or cashier that or who in turn authorizes production through some process such as a “web call” from the POS.

In this example, the user would interact with the Card Kiosk by using a touch screen to choose a card design. The designs available would be limited only by digital storage space, either local or cloud, and could be meta-tagged for organization into one or more taxonomies to facilitate the user finding the best category, style, or other criteria. The selected card graphic could then be associated with a default text or verse for the cover and/or interior panel(s) and also a default design for the outside envelope to enclose the card. However, if the user preferred any different text or verse than the default text provided, there could be presented one or more alternative texts, or the user could substitute an alternative text or verse using any of various methods for the choice or input to compose the user's most “ideal” card. After the ideal card is composed it can be personalized by the user writing, drawing or signing anything on one of the sheets of paper provided at the kiosk which is pre-sized for an accurately registered graphical overlay, or by bringing a pre-signed sheet of paper, which can then be scanned at high resolution by the Card Kiosk's scanner for inclusion in the overall design to be remotely manufactured and mailed. Thus, the user is able to combine his or her best combination of graphic design, typeset appearing text or verse, and “handwritten personalization.” In the event the user is not satisfied with any of the elements to be incorporated into the card's design and appearance—for example, the superimposed, optically scanned personal note or signature is not “perfect”—then the user may simply “re-do” that part of the composition until the results are satisfactory or even “perfect.”

The Card Kiosk overcomes several disadvantages of the typical way greeting cards are currently selected, personalized and mailed. The limitations of the conventional method of retailing greeting cards, and the respective solutions afforded by the Card Kiosk invention, include:

Graphic Limitation—Someone shopping for a greeting card in a retail store must personally scan an array of pre-printed cards in display racks which may be more or less categorized by occasion or style for faster reference in the physical rack space. Since rack space occupies valuable retail area and since a relatively larger and larger inventory of cards is respectively more and more expensive to maintain, the available options of cards to the consumer are limited by at least these economic constraints.

Graphic Solution—there is no practical physical limitation to the number of designs presented to the consumer whether stored locally or online (the cloud).

Formal/Printed Sentiments Limitation—When a consumer finds a folded greeting card where the front panel, traditionally the graphic focus of the card, is preferred, often the interior text or verse is less than satisfactory and cannot be modified or removed.

Formal/Printed Sentiments Solution—The consumer may refer to an unlimited number of verses or text expressions of sentiment, e.g., Bartlett's Quotations™ or whatever, or supply original content to be included in the card's design.

Envelope Limitations—The consumer has few, if any, choices for the envelope design for the greeting card. The envelope design(s) are graphically fixed or static in any event. They cannot be customized except at the cost of significant expense and effort.

Envelope Solutions—The consumer may choose, submit, or combine any design to be digitally rendered in the manufacturing process of an envelope paired with any card or document format.

Handwriting Limitations—After the card is purchased, the consumer runs the often realized risk of making errors in the sentiment expressed or words chosen, spelling, or the actual physical handwriting itself including unsightly inked-over corrections or an erratic personal signature. Sometimes this ruins or at least damages the card.

Handwriting Solutions—Any number of draft submissions of personal notes, figures or signature may be scanned into the kiosk and presented in superimposition until one is “perfect” or at least satisfactory.

Mailing Limitation—The consumer is responsible for affixing the correct postage and entering the card or letter format into the postal mail stream if the card is not personally delivered to the recipient.

Mailing Solution—The turnkey process enabled by the Card Kiosk obviates most tasks associated with postal mailing; the Card Kiosk puts a “web call” demand on a remote production system for micro-fulfillment which mails the card on behalf of the user. Intelligent Mail Barcode and other technologies may be integrated into the mailing to provide benefits to the individual mailer not normally available to individuals, or only at prohibitive cost.

1. A method of generating a greeting card comprising:
a user selects at a template for a greeting card from a plurality of templates;
the user personalizes the greeting card with text or graphical information to create a graphic composition;
the user optically scans hand-written information at a kiosk;
the user superimposes the optically scanned hand written information with the graphic composition;
the user manufactures the greeting card at the kiosk by using a printer.

2. A method of generating a greeting card comprising:
a user selects at a template for a greeting card from a plurality of templates;
the user personalizes the greeting card with text or graphical information to create a graphic composition;
the user optically scans hand-written information at a kiosk;
the user superimposes the optically scanned hand written information with the graphic composition;
the user sends printing, manufacturing and mailing instructions for the greeting card to a remote manufacturing site; and,
the greeting card produced and mailed according to the user's instructions.
